(19) United States
(12) Patent Application Publication
(10) Pub. No.: US 2005/0282001 A1
(43) Pub. Date: Dec. 22, 2005

(54) Polyurethane compositions with glass filler and method of making same

(76) Inventors: Randall C. Jenkines, Dalton, GA (US); William A. Koonce, Pearland, TX (US); Larry W. Mobley, Cohutta, GA (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 11/156,077

(22) Filed: Jun. 17, 2005

Related U.S. Application Data
(60) Provisional application No. 60/580,519, filed on Jun. 17, 2004.

(51) Int. Cl. B32B 5/16

(52) U.S. Cl. 428/323; 428/221; 428/325

(57) ABSTRACT

The method forms a polyurethane article and involves dispersing polyurethane particles in a substantially aqueous liquid, mixing in a fine glass filler such as a post-consumer ground soda-lime glass, casting the filled dispersion and coalescing the particles by removing the liquid such that a polyurethane article having fused particles are formed. The polyurethane articles are useful as carpet backings.

### CROSS-REFERENCE TO RELATED APPLICATION

This application claims the benefit of U.S. Provisional Application Ser. No. 60,580,519, filed Jun. 17, 2004, which is hereby incorporated by reference.

### FIELD OF THE INVENTION

The invention relates to improved methods for incorporating glass fillers in polyurethane and glass filled polyurethanes made therefrom. In particular, the invention relates to a method allowing the incorporation of fine ground inorganic fillers, which may contain alkali into polyurethane articles.

### BACKGROUND OF THE INVENTION

Polyurethanes are produced by the reaction of polyisocyanates and polyols or polyamines (compounds having an active hydrogen). The first large scale commercial production of polyurethanes arose using polyester polyols from the ester condensation reaction of diols or polyols and dicarboxylic acids to make flexible foams. The polyester polyols were generally supplanted by polyether polyols because of lower cost and ability to make a wide range of polyols.

Solid fillers have been added to polyurethanes from almost the beginning of the production of polyurethanes. The fillers have been added, for example, to color, reinforce, decrease the flammability, change the density, and lower cost per unit volume of the polyurethane. The fillers have been organic or inorganic. For example, glass fibers and fibrous glass mats have been used to reinforce polyurethane elastomers and rigid polyurethane foams. Other fillers that have been used are clays, melamine, quartz and calcium carbonate.

Generally, when using particle fillers, particularly for flexible foams, the fillers have to be of a large size, because many of them, for example, calcium carbonate and siliceous containing mineral fillers will have water or active hydrogen at their surfaces that can react with the isocyanate. The amount of adsorbed water and/or active hydrogen increases as the particle surface area increases (the particles decrease in size). Because the particles have needed to be larger, (i.e., generally greater than about 100 micrometers), constant agitation typically is used to prevent settling until the polyurethane has cured sufficiently. Another problem that arises from using larger particles is wear on pumping and mixing equipment and contamination therefrom.

Recently, U.S. patent application Ser. No. 2003/0114625 has described the use of post consumer glass in polyurethane compositions. In an attempt to incorporate post-consumer glass, the application shows that glasses containing alkali components (e.g., sodium) are deleterious in making polyurethane, because it excessively accelerates the isocyanate—active hydrogen reaction. In addition, the application describes that glass particles retained on an 80 mesh screen (screen opening of 177 micrometers) settle too quickly and that glass particles passing through a 200 mesh screen (screen opening of 74 micrometers) create unacceptably viscous formulations.

Consequently, it would be desirable to provide a method of forming polyurethane, that is not limited by the chemistry or particle size so as to avoid some of the problems of the prior art as described above. In particular it would be desirable to provide polyurethane articles containing such particles.

### SUMMARY OF THE INVENTION

A first aspect of the invention is a method of incorporating a glass filler into a polyurethane article comprising:

(i) forming a dispersion of polyurethane particles in a substantially aqueous liquid,

(ii) mixing a glass particulate filler into the dispersion of polyurethane particles, wherein the glass filler has an alkali metal and an isoelectric point of at most 7 pH,

(iii) casting the dispersion into a shape, and

(iv) removing the liquid such that the polyurethane particles coalesce into the shape to form the polyurethane article. Surprisingly, the method allows the incorporation of glass filler with high concentrations of alkali metal without adversely affecting the polyurethane article.

A second aspect of the invention is a method of incorporating a glass filler into a polyurethane article comprising:

(i) forming a dispersion of polyurethane particles in a substantially aqueous liquid,

(ii) mixing a glass particulate filler into the dispersion of polyurethane particles, wherein the glass filler has a surface area of at least about 0.060 m²/g,

(iii) casting the dispersion into a shape, and

(iv) removing the liquid such that the polyurethane particles coalesce into the shape to form the polyurethane article. The method surprisingly allows the formation of polyurethane articles that incorporate glass particles of a small size and broad distribution improving the uniformity of the filler throughout the polyurethane, resulting in more uniform properties (i.e., less settling and segregation of the particles).

A third aspect of the invention is a polyurethane article comprised of polyurethane and a glass filler dispersed therein, the glass filler having a specific surface area of at least about 0.060 m²/g.

A fourth aspect of the invention is a polyurethane article comprised of polyurethane and glass filler dispersed therein, wherein the glass filler has an alkali metal, silicon and aluminum, the aluminum being present as an oxide (alumina) in the glass and the alumina being present in an amount of at most about 1% by weight.

A fifth aspect of the invention is a storage stable polyurethane dispersion comprising, polyurethane particles and glass particulates having an isoelectric point less than about pH 6 dispersed in a substantially aqueous liquid, wherein the dispersion has a pH of at least about 7. The dispersion is particularly useful in the methods of the first and second aspect of the invention.

The methods produce polyurethane articles useful for applications that typically have utilized polyurethane. The method and polyurethane articles are particularly suitable for use as coatings, laminates, flexible foams and the like for cushioning underlayments or backings for textile and non-textile flooring systems.

### DESCRIPTION OF THE FIGURES

FIG. 1: A 1000× electron micrograph of a frothed polyurethane foam of this invention showing the coalesced polyurethane particles and uniform distribution of the glass filler therein.

FIG. 2: A 1000× electron micrograph of a frothed polyurethane foam of a reactive A+B formed polyurethane having the typical calcium carbonate filler.

### DETAILED DESCRIPTION OF THE INVENTION

The method of the invention involves forming a dispersion of polyurethane particles in a substantially aqueous liquid. Substantially aqueous liquid, herein, means that the polyurethane particles are suspended in water that may have some organic solvent typically used to make polyurethane dispersions. Organic solvent means organic compounds typically used as solvents. Generally, organic solvents display a heightened flammability and vapor pressure (i.e., greater than about 0.1 mm of Hg). Generally, the amount of solvent is at most about 20% by volume of the liquid used to suspend the polyurethane particles. Preferably the amount of solvent is at most about 15%, more preferably at most about 10%, even more preferably at most about 5%, and most preferably at most about 2%.

In a preferred embodiment, the aqueous polyurethane dispersion is one in which the dispersion is substantially free of organic solvents. Substantially free of organic solvents means that the dispersion was made without any intentional addition of organic solvents to make the prepolymer or the dispersion. That is not to say that some amount of solvent may be present due to unintentional sources such as contamination from cleaning the reactor. Generally, the aqueous dispersion has at most about 1 percent by weight of the total weight of the dispersion. Preferably, the aqueous dispersion has at most about 2000 parts per million by weight (ppm), more preferably at most about 1000 ppm, even more preferably at most about 500 ppm and most preferably at most a trace amount of a solvent. In a preferred embodiment, no organic solvent is used, and the aqueous dispersion has no detectable organic solvent present (i.e., “essentially free” of an organic solvent).

The aqueous polyurethane dispersion may be any suitable polyurethane dispersion such as those known in the art. For example, the polyurethane dispersion may be an internally or externally stabilized dispersion or combination thereof.

An internally stabilized polyurethane dispersion is one that is stabilized through the incorporation of ionically or nonionically hydrophilic pendant groups within the polyurethane of the particles dispersed in the liquid medium. Examples of nonionic internally stabilized polyurethane dispersions are described by U.S. Pat. Nos. 3,905,929 and 3,920,598. Ionic internally stabilized polyurethane dispersions are well known and are described in col. 5, lines 4-68 and col. 6, lines 1 and 2 of U.S. Pat. No. 6,231,926. Typically, dihydroxyalkylcarboxylic acids such as described by U.S. Pat. No. 3,412,054 are used to make anionic internally stabilized polyurethane dispersions. A common monomer used to make an anionic internally stabilized polyurethane dispersion is dimethylolpropionic acid (DMPA).

An externally stabilized polyurethane dispersion is one that substantially fails to have an ionic or nonionic hydrophilic pendant groups and thus requires the addition of a surfactant to stabilize the polyurethane dispersion. Examples of externally stabilized polyurethane dispersions are described in U.S. Pat. Nos. 2,968,575; 5,539,021; 5,688,842; and 5,959,027.

The polyurethane dispersion may be mixed with another polymeric dispersion so as, for example, to impart a useful property or reduce cost. Other polymer dispersions or emulsions that may be useful when mixed with the polyurethane dispersion include polymers such as polyacrylates, polyisoprene, polyolefins, polyvinyl alcohol, nitrile rubber, natural rubber and co-polymers of styrene and butadiene. Most preferably, the polyurethane dispersion is used alone (i.e., not mixed with any other polymeric dispersion or emulsion).

Preferably, the dispersion is one that is comprised of a nonionizable polyurethane and an external stabilizing surfactant. A nonionizable polyurethane is one that does not contain a hydrophilic ionizable group. A hydrophilic ionizable group is one that is readily ionized in water such as DMPA. Examples of other ionizable groups include anionic groups such as carboxylic acids, sulfonic acids and alkali metal salts thereof. Examples of cationic groups include ammonium salts arising, for example, from the reaction of a tertiary amine and strong mineral acids such as phosphoric acid, sulfuric acid, hydrohalic acids or strong organic acids or by reaction with suitable quartinizing agents such as C1-C6 alkyl halides or benzyl halides (e.g., Br or Cl).

Generally, the nonionizable polyurethane is prepared by reacting a polyurethane/urea/thiourea prepolymer with a chain-extending reagent in an aqueous medium and in the presence of a stabilizing amount of an external surfactant. The polyurethane/urea/thiourea prepolymer can be prepared by any suitable method such as those well known in the art. The prepolymer is advantageously prepared by contacting a high molecular weight organic compound having at least two active hydrogen atoms with sufficient polyisocyanate, and under such conditions to ensure that the prepolymer is terminated with at least two isocyanate groups.

The polyisocyanate is preferably an organic diisocyanate, and may be aromatic, aliphatic, or cycloaliphatic, or a combination thereof. Representative examples of diisocyanates suitable for the preparation of the prepolymer include those disclosed in U.S. Pat. No. 3,294,724, column 1, lines 55 to 72, and column 2, lines 1 to 9, incorporated herein by reference, as well as U.S. Pat. No. 3,410,817, column 2, lines 62 to 72, and column 3, lines 1 to 24, also incorporated herein by reference. Preferred diisocyanates include 4,4′-diisocyanatodiphenylmethane, 2,4′-diisocyanatodiphenylmethane, isophorone diisocyanate, p-phenylene diisocyanate, 2,6 toluene diisocyanate, polyphenyl polymethylene polyisocyanate, 1,3-bis(isocyanatomethyl)cyclohexane, 1,4-diisocyanatocyclohexane, hexamethylene diisocyanate, 1,5-naphthalene diisocyanate, 3,3′-dimethyl-4,4′-biphenyl diisocyanate, 4,4′-diisocyanatodicyclohexylmethane, 2,4′-diisocyanatodicyclohexylmethane, and 2,4-toluene diisocyanate, or combinations thereof. More preferred diisocyanates are 4,4′-diisocyanatodicyclohexylmethane, 4,4′-diisocyanatodiphenylmethane, 2,4′-diisocyanatodicyclohexylmethane, and 2,4′-diisocyanatodiphenylmethane. Most preferred is 4,4′-diisocyanatodiphenylmethane and 2,4′-diisocyanatodiphenylmethane.

As used herein, the term “active hydrogen group” refers to a group that reacts with an isocyanate group to form a urea group, a thiourea group, or a urethane group as illustrated by the general reaction: 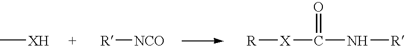
where X is O, S, NH, or N, and R and R′ are connecting groups which may be aliphatic, aromatic, or cycloaliphatic, or combinations thereof. The high molecular weight organic compound with at least two active hydrogen atoms typically has a molecular weight of not less than 500 Daltons.

The high molecular weight organic compound having at least two active hydrogen atoms may be a polyol, a polyamine, a polythiol, or a compound containing combinations of amines, thiols, and ethers. Depending on the properties desired the polyol, polyamine, or polythiol compound may be primarily a diol, triol or polyol having greater active hydrogen functionality or a mixture thereof. It is also understood that these mixtures may have an overall active hydrogen functionality that is slightly below 2, for example, due to a small amount of monol in a polyol mixture.

As an illustration, it is preferred to use a high molecular weight compound or mixtures of compounds having an active hydrogen functionality of about 2 for a polyurethane dispersion used to make a carpet precoat or laminate coat whereas a higher functionality is typically more desirable for a polyurethane dispersion used to make foam by frothing as a cushioning layer for a carpet. The high molecular weight organic compound having at least two active hydrogen atoms may be a polyol (e.g., diol), a polyamine (e.g., diamine), a polythiol (e.g., dithiol) or mixtures of these (e.g., an alcohol-amine, a thiol-amine, or an alcohol-thiol). Typically the compound has a weight average molecular weight of at least about 500.

Preferably, the high molecular weight organic compound having at least two active hydrogen atoms is a polyalkylene glycol ether or thioether or polyester polyol or polythiol having the general formula: 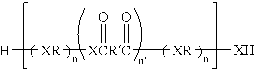
where each R is independently an alkylene radical; R′ is an alkylene or an arylene radical; each X is independently S or O, preferably O; n is a positive integer; and n′ is a non-negative integer.

Generally, the high molecular weight organic compound having at least two active hydrogen atoms has a weight average molecular weight of at least about 500 Daltons, preferably at least about 750 Daltons, and more preferably at least about 1000 Daltons. Preferably, the weight average molecular weight is at most about 20,000 Daltons, more preferably at most about 10,000 Daltons, more preferably at most about 5000 Daltons, and most preferably at most about 3000 Daltons.

Polyalkylene ether glycols and polyester polyols are preferred, for example, for making a polyurethane dispersion for making foams, precoat layers and other layers useful for making carpet backing. Representative examples of polyalkylene ether glycols are polyethylene ether glycols, poly-1,2-propylene ether glycols, polytetramethylene ether glycols, poly-1,2-dimethylethylene ether glycols, poly-1,2-butylene ether glycol, and polydecamethylene ether glycols. Preferred polyester polyols include polybutylene adipate, caprolactone based polyester polyol and polyethylene terephthalate. In addition, bio-based polyols are also preferred such as those described in International Patent Application No. WO 04/12427, designating the U.S., and U.S. Pat. Nos. 4,423,162; 4,496,487; and 4,543,369, each incorporated herein in its entirety.

Preferably, the NCO:XH ratio, where X is O or S, preferably 0, is not less than 1.1:1, more preferably not less than 1.2:1, and preferably not greater than 5:1.

The polyurethane prepolymer may be prepared by a batch or a continuous process. Useful methods include methods such as those known in the art. For example, a stoichiometric excess of a diisocyanate and a polyol can be introduced in separate streams into a static or an active mixer at a temperature suitable for controlled reaction of the reagents, typically from about 40° C. to about 100° C. A catalyst may be used to facilitate the reaction of the reagents such as an organotin catalyst (e.g., stannous octoate). The reaction is generally carried to substantial completion in a mixing tank to form the prepolymer.

The external stabilizing surfactant may be cationic, anionic, or nonionic. Suitable classes of surfactants include, but are not restricted to, sulfates of ethoxylated phenols such as poly(oxy-1,2-ethanediyl)α-sulfo-ω(nonylphenoxy) ammonium salt; alkali metal fatty acid salts such as alkali metal oleates and stearates; polyoxyalkylene nonionics such as polyethylene oxide, polypropylene oxide, polybutylene oxide, and copolymers thereof; alcohol alkoxylates; ethoxylated fatty acid esters and alkylphenol ethoxylates; alkali metal lauryl sulfates; amine lauryl sulfates such as triethanolamine lauryl sulfate; quaternary ammonium surfactants; alkali metal alkylbenzene sulfonates such as branched and linear sodium dodecylbenzene sulfonates; amine alkyl benzene sulfonates such as triethanolamine dodecylbenzene sulfonate; anionic and nonionic fluorocarbon surfactants such as fluorinated alkyl esters and alkali metal perfluoroalkyl sulfonates; organosilicon surfactants such as modified polydimethylsiloxanes; and alkali metal soaps of modified resins.

The polyurethane dispersion may be prepared by any suitable method such as those well known in the art. (See, for example, U.S. Pat. No. 5,539,021, column 1, lines 9 to 45, which teachings are incorporated herein by reference.)

When making the polyurethane dispersion, the prepolymer may be extended by water solely, or may be extended using a chain extender such as those known in the art. When used, the chain extender may be any isocyanate reactive diamine or amine having another isocyanate reactive group and a molecular weight of from about 60 to about 450, but is preferably selected from the group consisting of: an aminated polyether diol; piperazine, aminoethylethanolamine, ethanolamine, ethylenediamine and mixtures thereof. Preferably, the amine chain extender is dissolved in the water used to make the dispersion.

In a preferred method of preparing the polyurethane dispersion, a flowing stream containing the prepolymer is merged with a flowing stream containing water with sufficient shear to form the polyurethane dispersion. An amount of a stabilizing surfactant, if used, is also present, either in the stream containing the prepolymer, in the stream containing the water, or in a separate stream. The relative rates of the stream containing the prepolymer (R2) and the stream containing the water (R1) are preferably such that the polydispersity of the HIPR emulsion (the ratio of the volume average diameter and the number average diameter of the particles or droplets, or Dv/Dn) is not greater than about 5, more preferably not greater than about 3, more preferably not greater than about 2, more preferably not greater than about 1.5, and most preferably not greater than about 1.3; or the volume average particle size is not greater than about 2 microns, more preferably not greater than about 1 micron, more preferably not greater than about 0.5 micron, and most preferably not greater than about 0.3 micron. Furthermore, it is preferred that the aqueous polyurethane dispersion be prepared in a continuous process without phase inversion or stepwise distribution of an internal phase into an external phase.

The surfactant is sometimes used as a concentrate in water. In this case, a stream containing the surfactant is advantageously first merged with a stream containing the prepolymer to form a prepolymer/surfactant mixture. Although the polyurethane dispersion can be prepared in this single step, it is preferred that a stream containing the prepolymer and the surfactant be merged with a water stream to dilute the surfactant and to create the aqueous polyurethane dispersion.

The dispersion may have any suitable solids loading of dispersion polyurethane particles, but generally the solids loading is as great as practicable. Generally, the solids loading may be between about 10% to about 80% solids by weight of the total dispersion weight. Higher solids loading is preferred because it aids in the speed that the polyurethane can be dried and coalesced. Preferably the solids loading is at least about 20%, more preferably at least about 30% and most preferably at least about 40% to preferably at most about 75%, more preferably at most about 65% and most preferably at most about 60% by weight.

The dispersion may also contain a rheological modifier such as thickeners that enhance the ability of the dispersion to retain, for example, it shape upon casting onto a substrate such as when a foam cushion layer is cast onto a carpet to form a carpet cushion backing. Any suitable rheological modifier may be used such as those known in the art. Preferably, the rheological modifier is one that does not cause the dispersion to become unstable. More preferably, the rheological modifier is a water soluble thickener that is not ionized. Examples of useful rheological modifiers include methyl cellulose ethers, alkali swellable thickeners (e.g., sodium or ammonium neutralized acrylic acid polymers), hydrophobically modified alkali swellable thickeners (e.g., hydrophobically modified acrylic acid copolymers) and associative thickeners (e.g., hydrophobically modified ethylene-oxide-based urethane block copolymers). Preferably the rheological modifier is a hydrophobically modified ethylene-oxide-based urethane block copolymers like those under the tradename ACRYSOL available from Rohm and Haas, Philadelphia, Pa.

The amount of thickener may be any useful amount. Typically the amount of thickener is at least about 0.1% to about 5% by weight of the total weight of the dispersion. Preferably the amount of thickener is between about 0.5% to about 2% by weight.

Other additives such as those known in the art may be added to the polyurethane dispersion to impart some desired characteristic to the polyurethane article. For example water repellant additives like calcium and zinc stearates, waxes and wax dispersions, pigments for color, ATH (aluminum trihydrate) for flame resistant properties, urea to alter polymer melt flow melt characteristics, CaCO₃ filler to extend the polymer, and the like.

The polyurethane dispersions in the methods of the invention, are mixed with a glass particulate filler (glass filler herein). Herein a glass filler is particulate in nature and specifically does not include continuous fibers or chopped fibers. That is, the glass filler may be any morphology such as solid and hollow spheres and irregular shapes arising from grinding of glass.

The glass of the glass filler may be any amorphous ceramic, but preferably, the glass filler is an amorphous oxide. More preferably, the glass is a silicate. More preferably, the glass is a silicate that contains an alkali such as sodium. The silicate glass also, preferably, has an alkaline earth such as calcium. In one preferred embodiment, the glass filler is a soda-lime silicate glass such as those known in the art and include glasses typically referred to as plate glass and bottle glass (see, for example, U.S. Pat. Appl. Pub. 2003/0114625). In a particularly, preferred embodiment, the soda-lime silicate glass has an alumina concentration of at most about 1% by weight of the soda-lime glass, such as those commercially available from Potters Industries Inc., Berwyn, Pa. (e.g., Glass Fill C and D). Generally, when a soda-lime glass is used, the Na₂O is at least about 10% to about 20% and the CaO is at least about 3% to about 15% by weight of the glass.

Even though the glass filler may be of any density, it advantageously has a density from about 2 to 4 g/cc. Preferably, the density is at least about 2.2 to preferably at most about 3.5, more preferably at most about 3 g/cc. Of course if the glass filler is hollow, the glass density, is as just described, but the bulk density may be much lower as desired and determinable by one of ordinary skill in the art depending on the application.

When adding a glass containing sodium and calcium, it is preferred to raise the pH of the dispersion to at least about 7.5, more preferably at least about 8, and most preferably at least about 8.5 prior to the addition of the filler, during or shortly (several minutes) after adding the glass filler. The pH, however should not be too high, so as to avoid, for example, dissolving of the glass. Generally, the pH is at most about 10.5, preferably at most about 10. The raising of the pH has been found to reduce the tendency of the dispersion to build viscosity that has been attributed to an increase in pH that may be due to the leaching of soda from the glass. The increasing viscosity may be due to changes occurring to the dispersion stability or the activity of the thickener increasing.

Any compound may be used to raise the pH (pH raising compound), but it is preferred that the compound also sequester multivalent cations that may be in solution such as Ca ions that may leach from the soda-lime silicate glass. Exemplary pH raising compounds include mineral bases, ammonia, polyelectrolyte compounds such as those described in U.S. Pat. No. 4,797,223 including those available from Rohm and Haas Company under the tradename TAMOL, and Para-Chem Specialties, Dalton, Ga. under the tradename STANSPERSE, phosphate compounds such as trisodium phosphate, basic ethoxylated organophosphate esters, and combinations thereof. It is understood that the pH raising compound at least partially dissolves in the substantially aqueous liquid and may be present in a disassociated state within the liquid.

In one embodiment of the present invention, the polyurethane dispersion is mixed with a glass filler having specific surface area of at least 0.060 m²/g. The equivalent spherical diameter of such glass filler assuming a density of about 2.7, which is typical for silicate glasses, is about 37 micrometers in diameter. This is substantially less than particles retained on a 325 mesh screen, which has a screen opening of about 44 micrometers. The ability to use a fine powder allows for a much more uniform dispersion of the filler particles arising for example from larger particles segregating. Preferably, the specific surface area of the glass filler particles is at least about 0.1 m²/g, more preferably at least about 0.15 m²/g, even more preferably at least about 0.2 m²/g, and most preferably at least about 0.4 m²/g to preferably at most about 20 m²/g. Too high a filler specific surface area is not useful, because it tends to limit the amount of filler that can be incorporated due to excessive increases in the dispersion viscosity.

In addition to the specific surface area of the filler, the filler advantageously has a wide particle size distribution aiding in the incorporation of high levels of filler without an excessive viscosity increase. Generally the filler particles have distribution in which the d90 particle size is at least 2 times larger than the median (d50) particle size. The d90 particle size is the size that is larger than 90% of the particles in the filler. Preferably, the d90 particle size is at least about 2.25 and more preferably at least about 2.5 times larger than the median particle size (d50) by volume. It is also preferred that the d10 particle size is at least 2 times smaller than the median particle size of the filler. More preferably, the d10 is 3 times smaller and most preferably 4 times smaller than the median particle size by volume.

The glass filler advantageously has a median particle size by volume of at most about 120 micrometers in diameter. Preferably the median particle size is at most about 100 micrometers, more preferably at most about 90 micrometers, even more preferably at most about 50 micrometers and most preferably at most about 30 micrometers to preferably at least about 1 micrometer and more preferably at least about 10 micrometers.

In another embodiment, the glass filler mixed with the polyurethane dispersion has an alkali metal and an isoelectric point of at most 6 pH units. Such glasses may surprisingly be used with polyurethane dispersions, for example, that have isoelectric points that are at least pH 6 or even pH 7 using the method of this invention. In a preferred embodiment, the pH of the dispersion is raised as previously described, whereas in the absence of raising the pH it has been found the dispersion builds viscosity and coagulates. The isoelectric point is the pH where particles within water fail to display a charge in an electric field and may be determined by known methods such as those used to determine zeta potentials. Preferably, the glass filler has an isoelectric point of at most about 5.5 pH, more preferably at most about 5 pH, and most preferably at most 4 pH to preferably at least about 0.5 pH.

Generally, the dispersion including the glass filler will have a viscosity that is, for example, easily pumpable, while still being able to be cast and retain its shape to form the polyurethane article. Generally the viscosity is from at least about 1000 centipoise (cp) to at most about 40,000 cp as measured using a Brookfield Model RVDVE 115 viscometer employing a #6 spindle rotated at 20 revolutions per minute (rpm). Preferably, the viscosity is at least about 5000 cp to at most about 30000 cp. More preferably, the viscosity is at least about 10000 cp to at most about 25000 cp. It is also preferable for the dispersion to display non-Newtonian pseudoplastic behavior. This rheology resists filler fall-out, aids in coating placement and coating weight control.

To form the polyurethane article, the dispersion is cast by any suitable method to form a shape, laminate, layer or the like such as those known in the art. For example, when applying a precoat, laminate coat or cushion layer on a carpet, a doctor blade method may be used followed by heating the layer to remove the liquid from the dispersion and to form the layer/backing on the carpet. A double tandem roller coating device is the preferred method for laminate carpet backing products.

Likewise, the liquid of the cast dispersion may be removed by any suitable method, such as those known in the art. Illustratively, the liquid may be removed by simply allowing it to evaporate in air or by heating by known methods. Known methods of heating include, passing, for example, a carpet having the cast polyurethane dispersion thereon over a heating plate, IR heating, convection heating and the like.

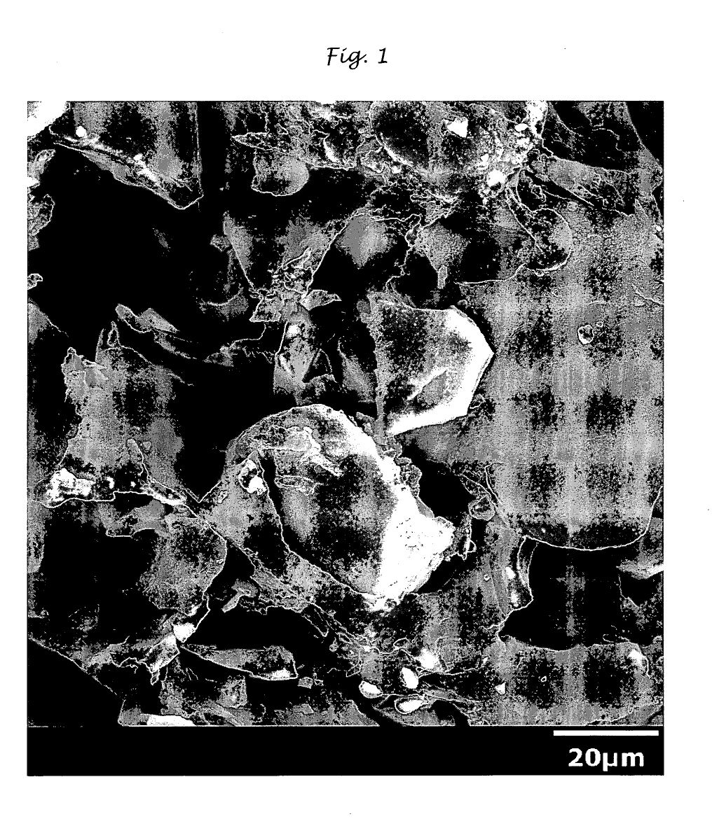

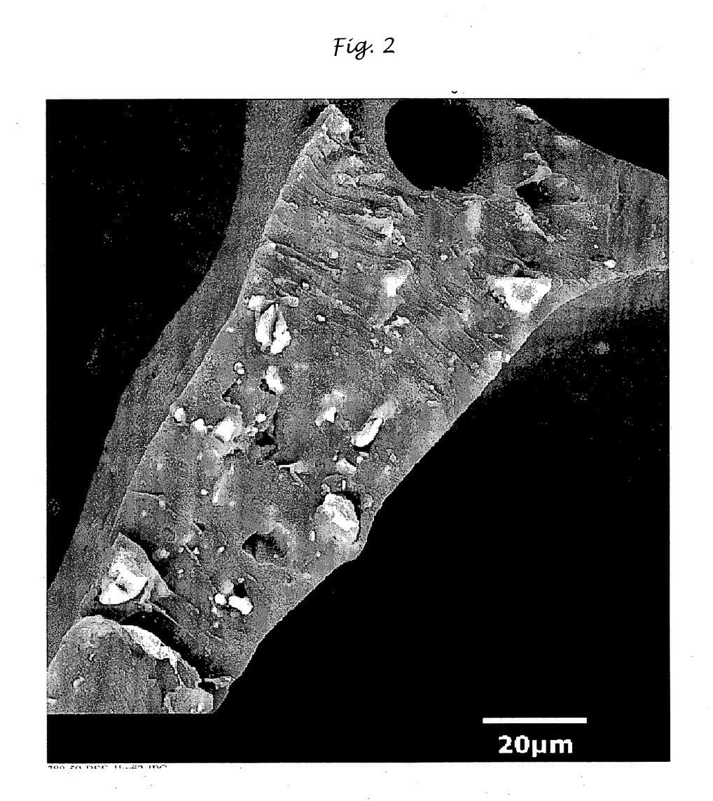

Surprisingly, the method allows the formation of a polyurethane article comprised of polyurethane and a glass filler dispersed therein, the glass filler having a specific surface area of at least about 0.060 m²/g. The article, because it has been formed by coalescing dispersed polyurethane particles allows the use of finely dispersed glass filler dispersed therein as shown in FIG. 1. This is in contrast to polyurethane articles such as foams prepared from reacting a polyisocyanate with a polyol using a typical filler (e.g., calcium carbonate) to form the foam as shown in FIG. 2.

Likewise, the method allows the formation of a polyurethane article comprised of polyurethane and glass filler dispersed therein, wherein the glass filler has an alkali metal, silicon and aluminum, the aluminum being present as an oxide in the glass and in an amount of at most about 1% by weight of the oxide of aluminum. The ability to form such an article is surprising, because such glass fillers are known to deleteriously cause the polyisocyanate to react too quickly with the polyol.

Generally, the polyurethane article is characterized by a microstructure that shows domains where the particles have coalesced (fused together wherein the particles have some intermingling-entanglement of their polymer chains, for example, due to heating such that the chains have enough mobility to intermingle such that the particles fuse together) as shown in FIG. 1. That is these polyurethane articles display a distinct grain boundary region between fused particles. This is in contrast with polyurethane articles that have been formed by reacting a polyisocyanate with a polyol as shown in FIG. 2, which are uniform throughout.

The amount of glass filler and any other filler within the polyurethane article may vary over a wide range depending on the properties and application. The glass filler may be the sole filler in the polyurethane article. Generally, the filler within the polyurethane article ranges from about 10% to about 90% by volume of the polyurethane article. Preferably the amount of filler is at least about 15%, more preferably at least about 30%, even more preferably at least about 40% to preferably at most about 75%, more preferably at most about 60 and most preferably at most about 50% by volume.

The polyurethane article is particularly useful as a carpet backing layer such as a laminate coat, precoat and foam cushioning layer.

### EXAMPLES

### Example 1

A filled dispersion (polyurethane dispersion having glass filler therein) was prepared by mixing in a pint container using a 2 inch Cowles blade rotating at 600 rpm the following components: 1) 10.2 grams of tap water, 2) 174 grams of SYNTEGRA* YA 503 an externally stabilized nonionizable polyurethane dispersion have a solids loading of about 57% by weight (The Dow Chemical Company, Midland, Mich.), 3) 0.2 grams of DREWPLUS L493 a defoamer, (Ashland Specialty Chemical Company, Boonton, N.J.), 4) 5.0 g of SYNPRO, zinc stearate wettable, (Ferro Corporation, Cleveland, Ohio), 5) 2.0 grams of TAMOL 731A pH raising compound (Rohm and Haas Company, Philadelphia, Pa.), 6) 250 grams of Glass Fill C (Potters Industries Inc., Brownwood, Tex.), and 7) 3.74 grams of ACRYSOL 12W a hydrophobically modified ethylene-oxide-based urethane block copolymer thickener (Rohm and Haas Company). The filled dispersion had a total solids content of 80.0% by weight, a Brookfield (RVT) viscosity of 21000 cps. (#6 spindle, 20 rpm), a specific gravity of 1.7 g/cc, and a pH of 8.91. After 7 days, the filled dispersion was tested again and had a reshear viscosity of 24850, pH of 8.91, and a solids content of 80.5% by weight.

The Glass Fill C filler had a d10 of 20.6 micrometers, d50 of 89.4 micrometers, and d90 of 203.8 micrometers as determined by light scattering using a Malvern Mastersizer 2000. The surface area was 0.199 m²/g. The chemistry was SiO₂: 68-75%, Na₂O 12-15%, CaO 7-10%, ZnO<0.005%, Fe₂O₃<1.0%, TiO₂<0.3%, Al₂O₃<1.0%, P₂O₅<0.1 and SO₃<1.0 in weight % as given by the manufacture.

The filled dispersion was applied to the backside of carpet style “Certificate” greige goods (available from J&J Industries, Dalton, Ga.) using standard coating rollers. This carpet style was a straight stitch 1/10 gauge continuous nylon tufted fabric having a greige weight of 1078 g/m². The tentered carpet specimen was cured in a 200° C. forced air lab oven until the backing temperature, as measure by an IR pyrometer, reached 129° C. The carpet specimen, conditioned at 25° C. and 50% relative humidity for 24 hours, had the following properties: 1) sample weight of 244.7 g/m², 2) coating weight of 1366.5 g/m², 3) tuftbind of 5.4 Kg., (ASTM D1335) 4) wet tuft bind of 4.3 Kg. (ASTM D1335 except that the specimen is soaked in water for 20 minutes before testing) and 5) British spill pass rating (United Kingdom Health Care Specifications Method E).

### Example 2

A filled polyurethane dispersion was prepared by mixing in a pint container, using a 2 inch Cowles blade rotating at 600 rpm, the following components: 1) 35 grams of tap water, 2) 175 grams of SYNTEGRA* YA 503 (The Dow Chemical Company), 3) 0.80 grams of DREWPLUS L493 (Ashland Chemical Company, 4) 5.0 grams of SYNPRO zinc stearate wettable (Ferro Corporation, city, state), 5) 200 g. of H&S #7 CaCO₃ filler (H&S Whiting Inc., Dalton, Ga.), 6) 100 grams of Q-Cel 6048 borosilicate glass hollow spheres (Potters Industries Inc.), and 7) 0.4 grams of ACRYSOL 8W rheology modifier (Rohm and Haas Company). The filled dispersion had a solids content of 78.4 wt. %, a Brookfield (RVT) viscosity of 16500 cps. (#6 spindle, 20 rpm) and a specific gravity of 1.02 g/cc.

The Q-Cel 6048 borosilicate glass hollow spheres had a d10 of 8.7 micrometers, d50 of 21.3 micrometers, and d90 of 48.3 micrometers measured using a Malvern Mastersizer. The surface area of the spheres was 0.153 m²/g. The chemistry was sodium salt of silicic acid (85 wt %), sodium salt of boric acid (15 wt %), as given by the manufacturer.

The filled dispersion was applied to the backside of carpet style “Certificate” greige goods (J&J Industries). This carpet style is a straight stitch 1/10 gauge continuous nylon tufted fabric having a greige weight of 1078 g/m². The tentered carpet specimen was cured in a 200° C. forced air lab oven until the backing temperature, as measure by an IR pyrometer, reached 129° C. The carpet specimen was conditioned at 25° C., 50% relative humidity 24 hours. The conditioned carpet specimen had the following properties: 1) sample weight of 2068 g/m², 2) coating weight of 990 g/m², 3) hand punch 9.0 Kg., 4) tuftbind of 6.1 Kg., 5) wet tuft bind of 4.0 Kg., and 6) British spill pass rating.

### Examples 3-6

Table 1 shows viscosity and pH data for Examples made in the same way as the Example 1 filled dispersion except that the dispersions were made with and without Tamol 731A and replacing Tamol 731A with Trisodium phosphate or NH₃OH as shown in Table 1. The raising of the pH prior to the mixing of the filler into the polyurethane dispersion to match the 2 day pH of the system not employing a pH raising compound prior to addition of the glass filler inhibits viscosity build during storage.

TABLE 1

| | | Initial | | | |
|---|---|---|---|---|---|
| | pH raising | Viscosity, | | 2 Day | |
| Example | compound | cp | Initial pH | Viscosity | 2 Day pH |
| 3 | None | 20400 | 8.08 | 26300 | 8.49 |
| 4 | Tamol 731A | 21000 | 8.31 | 19100 | 8.69 |
| | (0.5 php) | | | | |
| 5 | Trisodium | 21350 | 9.93 | 20000 | 9.68 |
| | phosphate | | | | |
| | (3 php) | | | | |
| 6 | NH₃OH | 18200 | 9.69 | 16150 | 9.62 |
| | (3 php) | | | | |

pHp = parts per hundred parts by weight

### Examples 7-14

Examples 7-14 were made in a similar fashion as Example 1 except that the components of the dispersions used were changed as shown in Table 2. Each of the dispersions and fillers of the Examples illustrate the applicability to make polyurethane articles such as carpet backings.

TABLE 2

| | Examples | | | | | | | |
|---|---|---|---|---|---|---|---|---|
| | 7 | 8 | 9 | 10 | 11 | 12 | 13 | 14 |
| Tap Water, g | 6 | 6 | 6 | 6 | 35 | 35 | 35 | 35 |
| SYNTEGRA YA 503 | 175.4 | 175.4 | 175.4 | 175.44 | 175.4 | 175.4 | 175.44 | 175.44 |
| Polyurethane Dispersion, | | | | | | | | |
| g | | | | | | | | |
| DrewPlus L493 | 0.4 | 0.4 | 0.4 | 0.4 | 0.4 | 0.4 | 0.4 | 0.4 |
| Defoamer, g | | | | | | | | |
| Synpro ZnSt Wettable, g | 5 | 5 | 5 | 5 | 5 | 5 | 5 | 5 |
| H&S#7 CaCO3 Filler, g | 125 | 125 | 125 | 125 | 200 | 200 | 200 | 200 |
| Glass Fill C, g | 75 | 0 | 0 | 0 | 100 | 0 | 0 | 0 |
| SPHERIGLAS 3000 Solid | 0 | 75 | 0 | 0 | 0 | 100 | 0 | 0 |
| Glass Spheres | | | | | | | | |
| EXTENDOSPERES TG | 0 | 0 | 75 | 0 | 0 | 0 | 100 | 0 |
| Hollow Ceramic | | | | | | | | |
| Microspheres | | | | | | | | |
| Q-CEL 6048 Borosilcate | 0 | 0 | 0 | 75 | 0 | 0 | 0 | 100 |
| Glass Hollow Spheres | | | | | | | | |
| DrewPlus L493 | 0.4 | 0.4 | 0.4 | 0.4 | 0.4 | 0.4 | 0.4 | 0.4 |
| Defoamer, g | | | | | | | | |
| Acrysol 8W Thickener, g | 3.8 | 4.96 | 0.8 | 0.65 | 7.21 | 7.62 | 1.93 | 0.8 |
| Viscosity, cps (#6@ 20 | 18,850 | 24450 | 19800 | 31300 | 18250 | 17500 | 25600 | 16500 |
| RPM) | | | | | | | | |
| Filled dispersion density, | 1.49 | 1.42 | 1.07 | 0.94 | 1.57 | 1.59 | 1.14 | 1.02 |
| g/cc | | | | | | | | |
| Solids, % | 78.7 | 78.7 | 78.7 | 78.7 | 78.4 | 78.4 | 78.4 | 78.4 |
| Coating Weight, g/MM | 1739 | 1756 | 1176 | 1085 | 1976 | 1973 | 1220 | 990 |
| Tuftbind, Kg | 8.09 | 8.95 | 7.14 | 5.23 | 7.18 | 7.27 | 6.73 | 6.09 |
| Wet Tuftbind, Kg | 5.18 | 5.86 | 5.09 | 3.36 | 4.36 | 5.09 | 4.59 | 3.95 |
| British Spill | Pass | Pass | Pass | Pass | Pass | Pass | Pass | Pass |

EXTENDOSPHERES TG: available from Potters Industries Inc Chattanooga, TN 37404. The Malvern Mastersizer 2000 results d10 = 12.2, d50 = 37.2, d90 = 83.9. Supplier gives composition as a mixture of up to 5 wt % crystalline silica, mullite, and glass.
SPHERIGLAS 3000: available from Potters Industries Inc Chattanooga, TN 37404. The Malvern Mastersizer 2000 results d10 = 27.0, d50 = 38.9, d90 = 55.4. Supplier gives composition soda-lime glass.

1. A method of incorporating a glass filler into a polyurethane article comprising:
(i) forming a dispersion of polyurethane particles in a substantially aqueous liquid,
(ii) mixing a glass particulate filler into the dispersion of polyurethane particles, wherein the glass filler has an alkali metal and an isoelectric point of at most 6 pH,
(iii) casting the dispersion into a shape, and
(iv) removing the liquid such that the polyurethane particles coalesce into the shape to form the polyurethane article.

2. The method of claim 1 wherein the glass particulate filler has a specific surface area of at least about 0.060 m²/g.

3. The method of claim 2, wherein the glass particulate filler has a specific surface area of at least about 0.1 m²/g.

4. The method of claim 1 wherein prior to, during or shortly after mixing the glass particulate filler into the dispersion, the pH of the polyurethane dispersion is raised using a pH raising compound to a raised pH of at least about 7.5.

5. The method of claim 4, wherein the raised pH is at least 8.

6. The method of claim 5, wherein the raised pH is at least 8.5.

7. The method of claim 1 wherein the isoelectric point of the glass particulate filler is at most about 5.5 pH.

8. The method of claim 7 wherein the polyurethane particles have an isoelectric point of at least about 7 pH.

9. The method of claim 1 wherein the glass particulate filler is a soda-lime silicate glass.

10. The method of claim 9 wherein the glass particulate has alumina at a concentration of greater than zero to at most about 1% by weight of the glass particulate filler.

11. A method of incorporating a glass filler into a polyurethane article comprising:
(i) forming a dispersion of polyurethane particles in a substantially aqueous liquid,
(ii) mixing a glass particulate filler into the dispersion of polyurethane particles, wherein the glass filler has a surface area of at least about 0.060 m²/g,
(iii) casting the dispersion into a shape, and
(iv) removing the liquid such that the polyurethane particles coalesce into the shape to form the polyurethane article.

12. The method of claim 11 wherein the surface area is at least about 0.1 m²/g.

13. The method of claim 11 wherein the glass filler is an oxide glass.

14. The method of claim 13 wherein the glass filler is a silicate glass.

15. The method of claim 14 wherein the glass filler is a soda-lime silicate glass having at most 1% by weight of alumina.

16. The method of claim 11 wherein the glass filler has a median particle size (d50) of at most about 100 micrometers in diameter by volume, a d90 particle size that is at least 2 times larger than the median particle size and a d10 that is at least 3 times smaller than the median particle size by volume.

17. A polyurethane article comprised of polyurethane and glass filler dispersed therein, wherein the glass filler has an alkali metal, silicon and aluminum, the aluminum being present as alumina in the glass and the alumina being present in an amount of at most about 1% by weight of the glass filler.

18. The polyurethane article of claim 17 wherein the glass filler has a specific surface area of at least about 0.060 m²/g.

19. The polyurethane article of claim 18 wherein the specific surface area is at least about 0.1 m²/g.

20. The polyurethane article of claim 17 wherein the glass filler is the sole filler.

21. The polyurethane article of claim 17 wherein the glass filler has a median particle size (d50) of at most about 100 micrometers in diameter by volume, a d90 particle size that is at least 2 times larger than the median particle size and a d10 that is at least 3 times smaller than the median particle size by volume.

22. The polyurethane article of claim 17 wherein the polyurethane is comprised of polyurethane particles fused together.

23. A carpet comprised of a precoat, laminate coat, cushion backing or combination thereof, the precoat, laminate coat, cushion backing or combination thereof being the polyurethane article of claim 17.

24. A polyurethane article comprised of polyurethane and a glass filler dispersed therein, the glass filler having a specific surface area of at least about 0.060 m²/g.

25. The polyurethane article of claim 24 wherein the specific surface area is at least about 0.1 m²/g.

26. The polyurethane article of claim 24 wherein the glass filler is a silicate glass.

27. The polyurethane article of claim 26 wherein the silicate glass is a soda-lime silicate glass.

28. The polyurethane article of claim 24 wherein the polyurethane is comprised of polyurethane particles fused together.

29. The polyurethane article of claim 24 wherein the glass filler is comprised of hollow spheres.

30. The polyurethane article of claim 24 wherein the glass is the sole filler in the polyurethane article.

31. The polyurethane article of claim 24 wherein the glass filler has a median particle size (d50) of at most about 100 micrometers in diameter by volume, a d90 particle size that is at least 2 times larger than the median particle size and a d10 that is at least 3 times smaller than the median particle size by volume.

32. A storage stable polyurethane dispersion comprising, polyurethane particles and glass particulates having an isoelectric point less than about pH 6 dispersed in a substantially aqueous liquid, wherein the dispersion has a pH of at least about 7.

33. The stable dispersion of claim 32 wherein the pH of the dispersion is at least 7.5.

34. The stable dispersion of claim 32 wherein the pH of the dispersion is at least 8.

35. The stable dispersion of claim 32 further comprising a pH raising compound.

36. The stable dispersion of claim 32 wherein the polyurethane particles have an isoelectric point of at least about pH 6.

37. The stable dispersion of claim 35 wherein the pH raising compound is ammonium hydroxide, trisodium phosphate, basic ethoxylated organophosphate esters, polyelectrolytes or combinations thereof.
